(19) United States
(12) Patent Application Publication
(10) Pub. No.: US 2025/0123781 A1
(43) Pub. Date: Apr. 17, 2025

(54) MONITORING DEVICE, CONTROL METHOD FOR MONITORING DEVICE, AND STORAGE MEDIUM

(71) Applicant: CANON KABUSHIKI KAISHA, Tokyo (JP)

(72) Inventor: MIGAKU YOSHIOKA, Kanagawa (JP)

(21) Appl. No.: 18/907,899

(22) Filed: Oct. 7, 2024

(30) Foreign Application Priority Data
Oct. 11, 2023 (JP) 2023-176257

(51) Int. Cl. G06F 3/12

(52) U.S. Cl. CPC G06F 3/1226; G06F 3/1203; G06F 3/1286

(57) ABSTRACT

A monitoring device monitoring information processing devices via a network searches for image processing devices on the network; in a case in which a plurality of image processing devices that have serial numbers that are the same but different IP addresses have been found during the search, confirms whether or not a device is an image processing device for expanding image processing relating to a print function; and manages, from among the plurality of image processing devices, an image processing device that is not an image processing device for expanding image processing relating to a print function as an image processing device that is a management target that are provided with a print function.

### BACKGROUND OF THE INVENTION

### Field of the Invention

The present invention relates to a monitoring device, a control method for a monitoring device, and a program.

### Description of the Related Art

Conventionally, a device management system is known that performs the maintenance of a device such as an image processing device or the like that has been installed in an office or the like via a network. By using this device management system, it is possible to detect and rapidly handle, for example, that damage has occurred to a device, that its consumables need to be replaced, or the like, via the network. As a conventional device management system, there is a configuration that directly monitors each device that has been connected to a network in an office by using a monitoring device that has been installed inside of the office. In addition, as the device management system, there is also a configuration that transmits information for each device that has been collected by a monitoring device that has been installed inside of the office to a device management server that centrally manages the devices on an external network. Japanese Unexamined Patent Application, First Publication No. 2016-92821 discloses a system that, in a case in which management is performed by linking data that the management server has received from a device to a device specific number (serial number) for this device, performs management in which it is possible to handle overlapping serial numbers by performing management by associating a device with an IP address.

A configuration exists in which a device and a device that functions as the controller of this device are connected to each other via only a network cable, and both the device and the controller are connected to a LAN. In such a configuration, in the technology from Japanese Unexamined Patent Application, First Publication No. 2016-92821, there are cases in which when searching for the IP address for the device and the IP address for the controller from a monitoring device that is connected to the same LAN, they are mistakenly recognized as different devices that have the same serial number but different IP addresses. In this manner, in a case in which a plurality of devices exist that have overlapping serial numbers (devices and controllers), it is no longer possible for the management client to correctly identify a device.

### SUMMARY OF THE INVENTION

The present invention manages image processing devices that have been provided with a print function as management targets, even in cases in which there are a plurality of image processing devices with overlapping serial numbers.

The monitoring device of the present invention is a monitoring device configured to monitor an image processing device via a network, the monitoring device comprising: a memory storing instructions; and a processor executing the instructions causing the monitoring device to: search for image processing devices on the network; in a case in which a plurality of image processing devices having serial numbers that are the same but different IP addresses have been found during the search, confirm whether or not an image processing device is an image processing device for expanding image processing relating to a print function; and manage, from among the plurality of image processing devices, an image processing device that is not an image processing device for expanding image processing relating to a print function as an image processing device that is a management target that is provided with a print function.

Further features of the present invention will become apparent from the following description of exemplary embodiments with reference to the attached drawings.

### BRIEF DESCRIPTION OF THE DRAWINGS

FIG. 1 is a diagram explaining a configuration of a device management system in a First Embodiment.

FIG. 2 is a diagram showing a hardware configuration of a monitoring device.

FIG. 3 is a flowchart showing device search processing in a First Embodiment.

FIG. 4 is a diagram showing one example of device information that is managed by a monitoring device in a First Embodiment.

FIG. 5 is a diagram explaining a configuration of a device management system in a Second Embodiment.

FIG. 6 is a flowchart showing device search processing in a Second Embodiment.

FIG. 7 is a diagram showing one example of device information that is managed by a monitoring device in a Second Embodiment.

FIG. 8 is a flowchart showing monitoring target device list acquisition processing in a Second Embodiment.

FIG. 9 is a diagram showing one example of device information that is managed by a management server in a Second Embodiment.

FIG. 10 is a flowchart showing ability check processing in a Third Embodiment.

### DESCRIPTION OF THE EMBODIMENTS

### First Embodiment

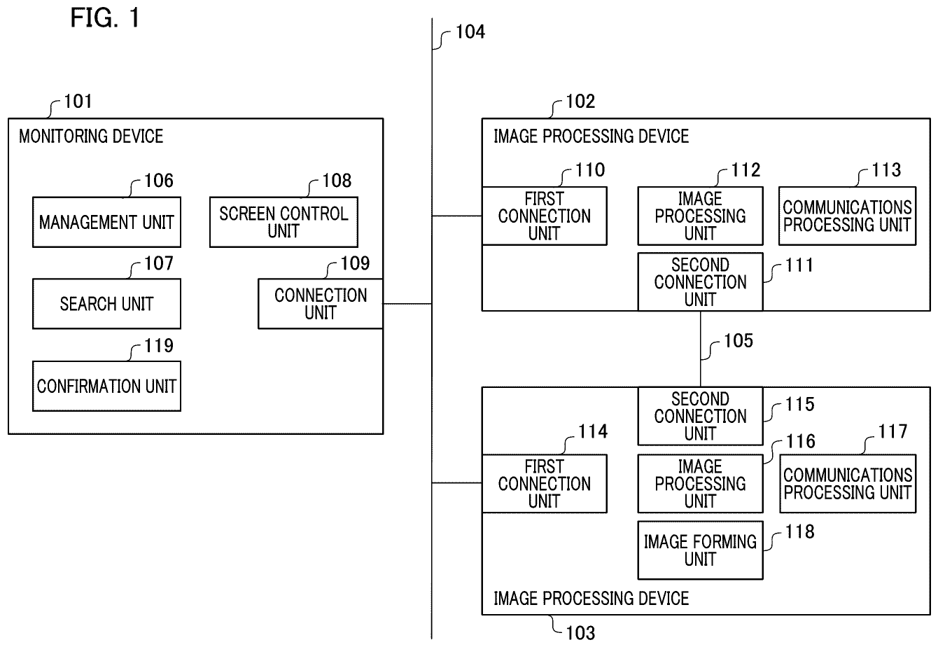

FIG. 1 is a diagram explaining a configuration of a device management system. In the Present Embodiment, an example will be explained in which the device management system manages image processing devices 103 that are network devices. The device management system of the Present Embodiment comprises a plurality of image processing devices, and a monitoring device 101. The plurality of image processing devices includes one or more image processing devices 103, which become management targets, and image processing devices 102 that are connected to image processing devices 103 and operate as print controllers.

The image processing device 103 that becomes a management target of the device management system is an image forming device such as, for example, an MFP (multifunction peripheral) that has a print function and a scan function. The image processing device 103 receives print data that has been received via the network and performs printing on actual paper or the like by using a well-known printing technology such as an electrophotographic technology, an inkjet technology, or the like, using the print function. The image processing device 103 reads original documents via a scanner and converts this to image data via a scan function. Note that for example, a network device may also be a single function printer that has only a print function, a scanner, a 3D printer, a laptop, a smartphone, or the like, instead of a device that performs communicable image processing.

The image processing device 102 is an image processing device (controller) for expanding image processing in relation to a print function. In addition, the image processing device 102 may also expand image processing other than the print function, such as a scan function that is executed in the image processing device 103. The image processing device 103, and the image processing device 102, which is a controller that expands a function of the image processing device 103, are connected to each other via a second network 105. The second network 105 is, for example, a local network. The second network 105 may also be a network cable. The information processing device 102 and the information processing device 103 are connected to each other by network communications that are represented by the TCP/IP format using the second network 105.

In addition, the monitoring device 101, the image processing device 102, and the image processing device 103 are connected to each other via a first network 104. The first network is, for example, a LAN (Local Area Network). The monitoring device 101, the image processing device 102, and the image processing device 103 connect to each other using network communications represented by the TCP/IP format. Note that it is sufficient if the network is configured so as to be able to send and receive data, and the communications format is not limited. For example, the network may also be configured by one of a LAN, a WAN, a cellular network such as LTE or 5G, a wireless network, a telephone line, a dedicated digital line, or the like, or a combination thereof.

The monitoring device 101 monitors and manages the image processing device 103, which is an image forming device that is connected to the first network 104, via the first network 104. The monitoring device 101 collects data from the image processing device 103. In contrast, the monitoring device 101 does not make the image processing device 102, which is a controller that expands a function of the image processing device 103, a monitoring target, and does not perform the collection of data for device management from the image processing device 102.

The monitoring device 101 has a management unit 106, a search unit 107, a screen control unit 108, and a connection unit 109. The management unit 106 manages the information for the image processing device 103, which is a management target. In addition, the management unit 106 performs the collection of various types of data, such as counter information, log information, status/alert information, or the like from the image processing device 103 that is a management target and is connected to the first network 104 via the connection unit 109.

The search unit 107 performs searches for image processing devices 102, and image processing devices 103 that are connected to the first network 104 via the connection unit 109. The confirmation unit 119 confirms whether or not an image processing device is a device for expanding image processing relating to a print function in order to confirm if a device from among the devices that have been found by the search unit 107 is a device that will become a management target of the monitoring device 101, or if this is a device that will not become a monitoring target of the monitoring device 101. In the Present Embodiment, the image processing device 102, which is a controller for expanding a function of the image processing device 103, is not a management target. In addition, the image processing device 103, which is an image forming device having a printer function (an image forming unit 118), becomes a management target of the monitoring device 101.

The screen control unit 108 performs control of a screen that is provided by the monitoring device 101. For example, the screen control unit 108 performs control of a WebUI that can be operated from another information device that is connected to the first network 104 via the connection unit 109. The connection unit 109 is a network interface for connecting the monitoring device 101 to the first network 104. Note that the monitoring device 101 connects to a WAN (wide area network) via a firewall, and may also connect to a management server that provides a service for managing devices, or the like.

The image processing device 103 has a first connection unit 110, a second connection unit 111, an image processing unit 112, and a communications processing unit 113. The first connection unit 110 is a network interface for connecting the image processing device 102 to the first network 104. The second connection unit 111 is an interface for connecting the image processing device 102 to the second network 105.

The image processing unit 112 processes print jobs that the image processing device 102 has received from other information devices on the first network 104, and performs the transfer of image data to the image processing device 103 via the second network 105. The communications processing unit 113 returns a response to searches and information acquisition requests from the monitoring device 101 via the first connection unit 110. In addition, the communications unit 113 performs the transfer of image data and the like to the image processing device 103 and the acquisition of data from the image processing device 103 via the second connection unit 111. Note that the image processing device 102 does not have an image forming unit that executes print processing.

The image processing device 103 has a first connection unit 114, a second connection unit 115, an image processing unit 116, a communications processing unit 117, and the image forming unit 118. The first connection unit 114 is a network interface for connecting the image processing device 103 to the first network 104. The second connection unit 115 is a network interface for connecting the image processing device 103 to the second network 105.

The image processing unit 116 processes print jobs that the image processing device 103 has received from the first network, and performs the generation of image data. In addition, the image processing unit 116 processes images that have been read on a reader, and performs the generation of image data. The image processing unit 116 outputs the image data that has been generated to the image forming unit 118. The communications processing unit 117 performs responses to data acquisition requests from the monitoring device 101 via the first connection unit 114. In addition, the communications processing unit 117 performs the reception of image data and the like and responds to data acquisition requests from the image processing device 102 via the second connection unit 1155. The image forming unit 118 performs the printing of image data that has been sent from the image processing unit 112 of the image processing device 102 or the image processing unit 116 of the image processing device 103.

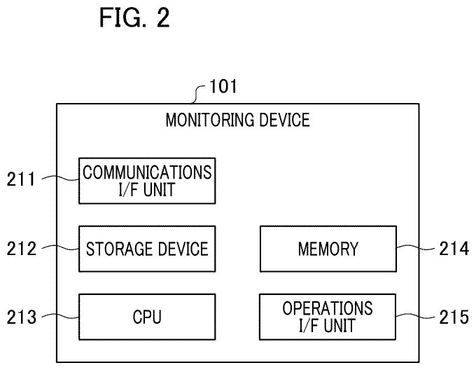

FIG. 2 is a diagram showing a hardware configuration of a monitoring device 101. The monitoring device 101 is provided with a CPU 213, a memory 214, a storage device 212, an operations I/F 215, and a communications I/F 211. The CPU 213 of the monitoring device 101 controls the entirety of the monitoring device 101. The CPU 213 realizes each type of control by loading a program from the storage device 212 onto the memory 214 and executing it. The storage device 212 stores an OS (operating system) and program, management data, data that has been collected from external systems and devices, and the like. The memory 214 functions as a working area or the like for the CPU 213. The operations I/F 215 outputs execution results for each type of data or the program or the like to an output device such as a display or the like that has been connected thereto, and receives inputs from an input device that has been connected thereto. The communications I/F 211 is a network interface for performing communications with external systems and devices.

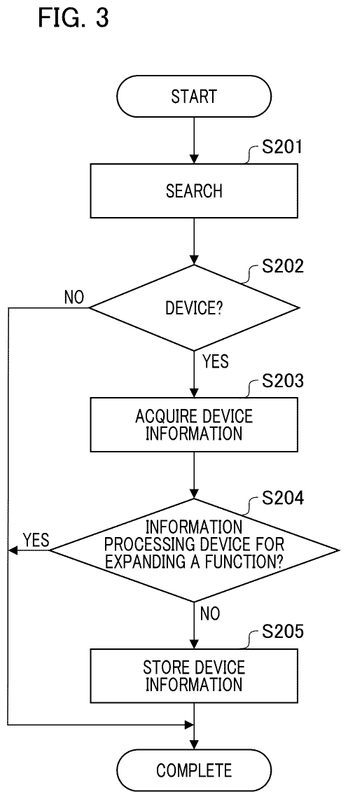

FIG. 3 is a flowchart showing device search processing by the monitoring device 101 in the First Embodiment. During the device search processing in the Present Embodiment, the monitoring device 101 searches for devices (image processing devices 102, image processing devices 103) on the first network 104, and if there are image forming devices that have print functions, stores this device information. In contrast, in a case in which a device is an image processing device (controller) for expanding a print function of an image forming device, this device information is not stored. In addition, in the present processing, in a case in which a device is not an image processing device (controller) for expanding the print function of an image forming device, it is determined that this is an image forming device that will become a device information storage target.

The device search processing may be executed at an arbitrary timing by a user operation that has been received on the screen control unit 108, or it may also be periodically performed based on a schedule that has been set in advance in the screen control unit 108 and a configuration file. Each processing that is executed by the monitoring device 101 during the device search processing is realized by the CPU 213 of the monitoring device 101 executing a program that has been stored on the storage device 212.

During S201, the search unit 107 performs a search for devices that are connected to the first network 104 via the connection unit 109. As the search method, an IP address that is input by a user as a search range on the screen control unit 108 may be searched for, or a search may also be performed by performing multicasting on a network to which the monitoring device 101 belongs. In this context, it is assumed that an acquisition request for a printer MIB (Management Information Base) is transmitted by unicast to a network address using an SNMP (Simple Network Management Protocol).

During S202, the search unit 107 confirms whether or not a device that returns a response to the search during S201 is a device. The search unit 107 determines whether or not this is a device based on whether or not a printer MIB has been able to be acquired. In a case in which a printer MIB has been acquired from a device, the search unit 107 determines that this is a device, and performs the processing for S203 in order to further acquire detailed information. In contrast, in a case in which the search unit 107 cannot acquire a printer MIB from a device, the search in relation to this address is completed. In the Present Embodiment, the communications processing unit 113 of the image processing device 102 and the communications processing unit 117 of the image processing device 103 return a printer MIB to the monitoring device 101, and therefore it is determined that the image processing device 102 and the image processing device 103 are devices.

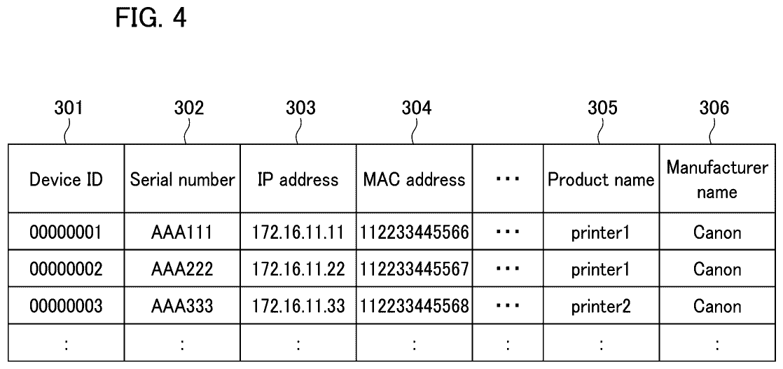

During S203, the search unit 107 acquires device information from the devices that have been determined to be devices during step S202. In this context, device information that is managed by the monitoring device 101 will be explained. FIG. 4 is a diagram showing one example of device information in the First Embodiment. The device information that is managed by the monitoring device 101 is device information for image processing devices having print functions, which are monitoring targets of the monitoring device 101, and this does not include device information for the image processing devices (controllers) for expanding image processing relating to a print function.

The device information includes, for example, a device ID 301, a serial number 302, an IP address 303, a MAC address 304, a product name 305, and a manufacturer name 306. The device ID 301 is information that uniquely identifies a device within the monitoring device 101. The serial number 302 is fixed identification information that is added by the manufacturer of the device in order to identify the device. The image processing device 103, which is an image forming device, has a serial number that was assigned to it in advance at the time of its manufacturing. In contrast, the image processing device 102, which is a controller for expanding a function of the image processing device 103, acquires and holds the serial number of the image processing device 103, which is the target of the function expansion. Specifically, the communications processing unit 113 of the image processing device 103 acquires the serial number of the image processing device 103 via the second network 105, and holds it. Therefore, the serial number that is held by the image processing device 102, which is a controller for expanding a function of the image processing device 103, is the serial number of the image processing device 103. Upon receiving a device information acquisition request from the monitoring device 101, the image processing device 102 returns device information including the same serial number as the serial number for the image processing device 103 to the monitoring device 101 to serve as the device information for the image processing device 102.

The IP address 303 is information that indicates the IP address of a device. In this context, although an explanation is given of an example in which an IP address is used as one example of access information for a device, a host name, a URL or the like may also be used. The MAC address 304 is fixed identification information that a network interface of a device has. The product name 305 is the product name for the device, which is set at the time of manufacturing by the manufacturer of the device. The manufacturer name 306 is the name of the manufacturer of the device, which is set at the time of manufacturing by the manufacturer of the device. Note that the IP address 303, the MAC address 304, the product name 305, and the manufacturer name 306, which are the device information for the image processing device 102 other than the serial number, are unique to the image processing device 102.

During S203, the search unit 107 acquires information other than the device ID, which is assigned by the management device 101, from among the device information that is shown in FIG. 4 from the device that has been determined as the device during step S202. Therefore, during step S203, the serial number, the IP address, the MAC address, the product name, and the manufacturer name are included in the device information that is acquired. During S203, from among the device information that the search unit 107 has acquired from both the image processing device 102 and the image processing device 103, the IP address and the like are different, but the serial numbers are the same information. Note that in addition to the device information that is shown in FIG. 4, the device information that is acquired during S203 may also include information that is acquired by a communications protocol that is unique to the maker, and which is defined by the maker of the image processing device.

During S204, the confirmation unit 119 confirms if the device is the image processing device 103 that has a print function, or if it is the image processing device 102 for expanding the image processing relating to the print function of the image forming device. Specifically, the confirmation unit 119 confirms whether or not the device is the image processing device 102 (controller) for expanding the image processing relating to the print function of the image forming device based on the information that has been acquired during S204. For example, in a case in which a specific character string exists in the information such as the product name 305, the manufacturer name 306, and the like that were acquired during S203, the confirmation unit 119 determines that the device is the image processing device 102. In addition, the confirmation unit 119 may also determine that the device is the image processing device 102 in a case in which the maker name is a specific string of characters and information cannot be acquired by the unique communications protocol of the maker. In addition, the confirmation unit 119 may also determine that the device is the image processing device 102 in a case in which the private MIB of the maker (the expansion MIB) can be acquired, but information cannot be acquired by the unique communications protocol of the maker. In this manner, the confirmation unit 119 confirms if a device is an image processing device for expanding image processing relating to a print function of an image forming device based on at least one of the product name, the maker name, and whether or not information can be acquired by the unique communications protocol of the maker. In a case in which it has been determined that a device is not the image processing device 102, the monitoring device 101 performs the processing for S205. In contrast, in a case in which it has been determined that a device is the image processing device 102, the monitoring device 101 completes the present processing.

During S205, the management unit 106 stores the device information that was acquired during S203 for the device that has been confirmed to be the image processing device 103. More specifically, in a case in which a device already exists for which the MAC address 304 overlaps, the management device 106 overwrites and stores the information on the corresponding device. If there is a device for which the MAC address 304 is not known, and for which the serial number overlaps with another device, the information is rewritten and stored on the corresponding device, or if there is no pre-existing information, this information is newly stored. In contrast, with respect to the device information that has been acquired during S3203 for a device that has been confirmed to be the image processing device 102 (controller) for expanding the image processing relating to the print function of the image processing device 103, the processing for S205 is not performed, and therefore, this information is not stored and is discarded. Even in a case in which the serial number for the image processing device 102 and the serial number for the image processing device 103 overlap, only the device information for the image processing device 103 is managed in the monitoring device 101, and therefore, it becomes possible to manage just the image processing device 103.

Even in a case in which the monitoring device 101 has found a plurality of image processing devices with different IP addresses and the same serial number during the search according to the above processing, it will confirm whether or not these are image processing devices for expanding the image processing relating to a print function. In addition, it becomes possible to manage the image processing device 103, which is not the image processing device 102 for expanding image processing relating to a print function, as the image processing device that is the management target and that is provided with a print function according to the confirmation results.

As has been explained above, in a case in which the monitoring device 101 detects a device using the device search, it identifies if this device is the image processing device 103 that has a print function, or if this is the image processing device 102 for expanding the image processing relating to the print function. If this device is the image processing device 103, the monitoring device stores the acquired information, and if this is the image processing device 102, it discards the acquired information, and it thereby becomes possible to manage just the image processing devices 103 even in cases in which the serial number for the image processing device 102 and the serial number for the image processing device 103 overlap.

### Second Embodiment

The First Embodiment shows a method for managing only the image processing devices 103 even if the serial numbers for a plurality of image processing devices (the image processing device 103, and the image processing device 102 for expanding a function thereof) overlap in cases in which the monitoring device 101 centrally manages the devices. In the First Embodiment, only the image processing devices 103 are managed, and therefore, processing was performed in which the information for the image processing devices 102 that were detected at the time of the search was not stored, and only the information for the image processing devices 103 was stored.

In contrast, a configuration also exists in which, the devices are centrally managed on a management server 403 on an external network, and the monitoring device 101 collects information for devices on an internal network and transmits information to the management server on the external network. In this configuration, the monitoring device 101 manages both the image processing devices 102 and the image processing devices 103, and it is possible to make it such that only the data for the image processing devices 103, which are the monitoring targets, is transmitted to the management server, and the data for the image processing devices 102, which are not the monitoring targets, is not transmitted. In this context, in the Present Embodiment, an explanation will be given with respect to a structure in which the monitoring device 101 makes only the image processing devices 103, which are the monitoring targets, the targets of the information transmission to the management server, while managing both the image processing devices 102, and the image processing devices 103, for which the serial numbers overlap.

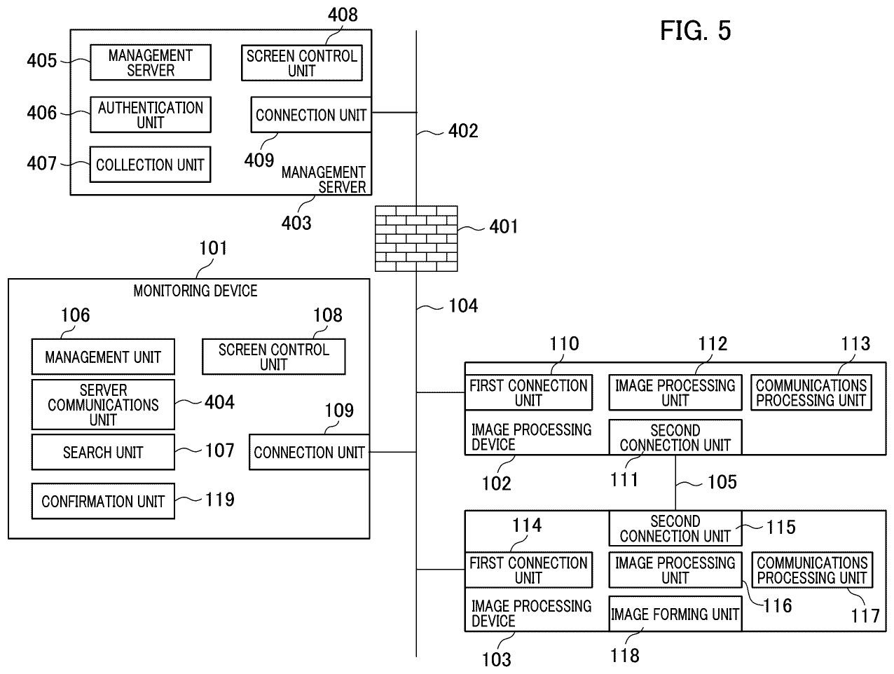

FIG. 5 is a diagram explaining a configuration of a device management system in the Second Embodiment. In the Present Embodiment, an example will be explained in which the device management system manages the image processing device 103, which is a network device. The device management system of the Present Embodiment includes the management server 403, which provides a device management service, one or more image processing devices 103, which become management targets, and image processing devices 102 that serve as print controllers that are connected to an image processing device 103, and a monitoring device 101. Note that configurations that are the same as the configurations in the First Embodiment will be assigned the same reference numbers, and explanations thereof will be omitted.

The management server 403 is an information processing device that provides a device management service. The target of the device management service is the image processing device 103, which is an image forming device having a print function. The management server 403 collects the device information for the image processing device 103, which is the management target, from the monitoring device 101. The management server 403 connects to a WAN 402. The WAN 402 connects to the first network 104 via a firewall 401. Therefore, the management server 403 connects to the monitoring device 101 via the WAN 402, the firewall 401, and the first network 104. For example, the first network 104 is an intracompany network, and the WAN 402 is a network that is external to the company. The firewall 401 is provided between the WAN 402 and the first network 104.

The management server 403 has a management unit 405, an authentication unit 406, a collection unit 407, a screen control unit 408, and a connection unit 409. Note that the management unit 405, the authentication unit 406, the collection unit 407, and the screen control unit 408 may also each be configured by separate servers that are connected to the WAN 402. In addition to one or more information processing devices, the functions of the management server 403 may also be realized by a virtual machine (a cloud service) that uses resources that have been provided by a data center that comprises an information processing device, or a combination thereof.

The management unit 405 manages the information processing device 103, which will become the target of each type of service of the device management system, and the information for the monitoring device 101 that monitors the image processing devices 103. The authentication unit 406 provides an authentication authorization function for safely connecting to the image processing devices 103 and the monitoring device 101. In this context, a general OAuth structure is used, and each device (the image processing devices 103, the monitoring device 101) is registered as a client that has been linked to a specific tenant. A tenant is a management unit that is assigned to each customer who has signed a usage agreement for the service. In the authentication unit 406, the management of data is performed with the unit of a tenant. Tokens are issued for these clients. By using these tokens, it becomes possible for a device that is a management target (the image processing device 103, the monitoring device 101) to access each function of the management server 403.

The collection unit 407 manages information that has been collected from the image processing device 102. The screen control unit 408 performs control of the screens that are provided by the management server 403. For example, the screen control unit 408 performs control of a WebUI that can be operated from another information device that is connected to the WAN 402 via the connection unit 409. The screen control unit 408 provides a maintenance service, each type of service such as a reporting service or the like, and a service for registering the information for the image processing devices 103 and the monitoring device 101 to the management unit 405 based on each type of information for the image processing devices 103 that is managed in the collection unit 407. The information for the image processing devices 103 and the monitoring device 101 that has been registered to the management unit 405 from the Web UI by a user can be acquired to serve as a monitoring target device list, which will be explained below. The connection unit 409 is a network interface for connecting the management server to the WAN 402.

Although the management server 403 in the Present Embodiment registers devices that the monitoring device 101, which has been installed on the intracompany network, makes monitoring targets from other information devices on an external network, and provides each type of service on the external network, it is not limited thereto. For example, the devices that will be made monitoring targets do not need to be specified by the management server 403, and may also be specified on the screen control unit 108 of the monitoring device 101. In the case of this configuration, the configurational diagram for the entire system is the same as the diagram in FIG. 1.

The monitoring device 101 in the Present Embodiment connects to the management server 403 via the first network 104, the firewall 401, and the WAN 402. The monitoring device 101 also has a server communications unit 404 in addition to the management unit 106, the search unit 107, the screen control unit 108, the connection unit 109, and the confirmation unit 119. The server communications unit 404 transmits the information for the image processing device 103 that was collected in the management unit 106 to the management unit 405 of the management server 403. In addition, the server communications unit 404 performs the acquisition of a monitoring target device list to be described below from the management unit 405 of the management server 403. When performing communications with the management server 403, the server communications unit 404 performs the registration of the monitoring device 101 and the devices using the authentication unit 406 of the management server 403, and acquires and manages the access token from the authentication unit 406. The server communications unit 404 performs communications with the management server by using the access token that has been acquired. Note that the hardware configuration of the monitoring device 101 is the same as the hardware configuration in the First Embodiment.

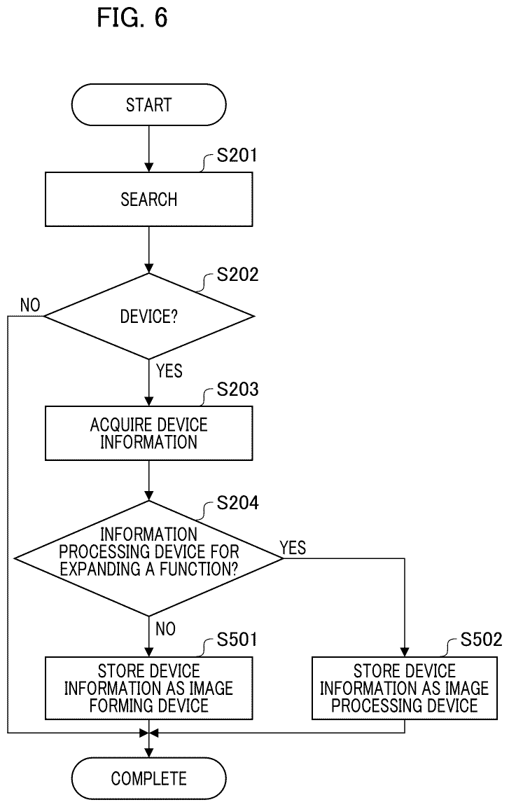

FIG. 6 is a flowchart showing device search processing for the monitoring device 101 in the Second Embodiment. In the Present Embodiment, when storing device information, in a case of an image forming device that has a print function, or in a case of an image processing device (controller) for expanding the print function of the image forming device, different types of device type information are stored, and it is made such that these can be differentiated.

The device search processing may also be executed at an arbitrary timing by a user operation that has been received by the screen control unit 108, or this may also be periodically executed based on a schedule that has been set in advance in the screen control unit 108 and the configuration file. Each processing that is executed by the monitoring device 101 during the device search processing is realized by the CPU 213 of the monitoring device 101 executing a program that has been stored on the storage device 212.

S201 to S204 are the same as the processing in the First Embodiment. During S204, the confirmation unit 119 confirms if a device is the image processing device 103 that has the print function or if it is the image processing device 102 for expanding image processing relating to the print function of the image forming device, and thereby confirms whether or not this device is a management target. Specifically, the confirmation unit 119 confirms whether or not a device is the image processing device 102 (controller) for expanding the image processing relating to a print function of the image forming device based on the information that was acquired during S203. For example, in a case in which a specific character string exists in the information such as the product name 305, the manufacturer name 306, and the like that were acquired during S203, the confirmation unit 119 determines that the device is an image processing device 102. In addition, the confirmation unit 119 may also determine that the device is the image processing device 102 in a case in which the manufacturer name is a specific string of characters and information cannot be acquired by the unique communications protocol of the maker. In addition, the confirmation unit 119 may also determine that the device is the image processing device 102 in a case in which the private MIB of the maker can be acquired, but information cannot be acquired by the unique communications protocol of the maker. In a case in which it has been determined that a device is not the image processing device 102 (controller), that is, in a case in which it has been determined that the device is an image forming device that has a printer function, the monitoring device 101 performs the processing for S501. In contrast, in a case in which the device is the image processing device 102 (controller), the monitoring device 101 performs the processing for S502.

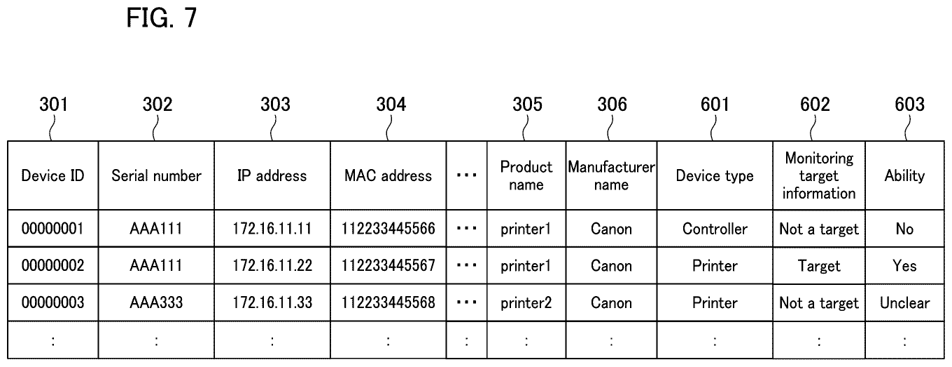

During S501, the management unit 106 adds the information that indicates that a device is an image forming device having a print function and stores the device information, and the present processing is completed. In this context, an explanation will be given of the device information that is managed by the monitoring device 101 in the Present Embodiment. FIG. 7 is a diagram showing one example of device information in the Second Embodiment. The device information in the Present Embodiment includes, for example, a device type 601, monitoring target information 602, and an ability 603 in addition to the device ID 301, the serial number 302, the IP address 303, the MAC address 304, the product name 305, and the manufacturer name 306.

The device type 601 is information that indicates if a device is an image forming device that has a print function, or if it is an image processing device (controller) for expanding image processing relating to the print function of the image forming device. The device type 601 stores a value that indicates “printer” in a case of an image forming device having a print function, and stores a value that indicates “controller” in a case of an image processing device (controller) for expanding image processing relating to a print function of the image forming device.

The monitoring target information 602 is information that indicates whether or not a device is monitored. A device is made a monitoring target in a case in which the device is included in the monitoring target device list that is acquired by the monitoring device 101 from the management server 403. The processing to determine whether or not a device is a monitoring target will be explained below. The monitoring target information 602 stores a value that indicates that the device is a “target” in a case in which the device is a monitoring target, and stores a value that indicates that the device is “not a target” in a case in which the device is not a monitoring target. Note that the image processing device 102, which is an image processing device (controller) for expanding image processing relating to the print function of the image forming device, is not registered on the monitoring target device list, and does not become a monitoring target.

The ability 603 is information that indicates whether or not a device has a self- monitoring ability. After a device search has been completed, the management unit 106 checks whether or not the device has the ability to acquire monitoring information, and stores information that indicates the presence or absence of a monitoring ability in the ability 603. Devices for which the monitoring target information 602 is “target” and the ability 603 is “yes” become targets for registration to the authentication unit 406 of the management server 403, and it becomes possible to perform monitoring of these devices by completing their registration to the authentication unit 406. Devices that have the ability to monitor themselves and that have been registered to the authentication unit 406 of the management server 403 can use a proxy server of the monitoring device 101 and transmit data that has been collected by self-monitoring to the management server 403. In contrast, data for devices for which the monitoring target information 602 is “target” but the ability 603 is “no”, is collected by poling by the monitoring device 101, and the data that has been collected is transmitted to the management server 403 by the monitoring device 101. In addition, in a case in which it is unclear whether or not the device has a monitoring ability, a value that indicates “unclear” is stored in the ability 603.

During S501, when device information is stored, in order to confer information that a device is an image processing device 103, the device type 601 is set as “printer”. At this time, there are no changes made to the monitoring target information 602. More specifically, in a case in which a device already exists for which the MAC address 304 overlaps, it is determined that these are the same device, and the information is over written and stored on the corresponding device. Even in cases in which there is an existing device for which the serial number 302 overlaps and for which the MAC address has not yet been acquired, it is determined that this is a device that was newly stored at the time of acquisition of the monitoring target device list, which will be described below, and the information is overwritten and saved on this device. In other cases, it is determined that the device has been newly found during the search, and the device information is newly stored with the monitoring target information 602 set as “not a target”.

During S502, the management unit 106 adds information that indicates that a device is an image processing device for expanding image processing relating to a print function of an image forming device, and information that indicates that this is not a management target, stores the device information, and completes the present processing. The management unit 106 makes the device type 601 “controller”, and the monitoring target information 602 “not a target”, and stores the device information. In a case in which a device already exists for which the MAC address 304 overlaps, it is determined that this is the same device, and the information for this device is over written and stored. In a case in which a device with an overlapping MAC address does not exist, it is determined that this is a device that has been newly found during the search, and the device information is newly stored.

According to the above processing, it is possible to include and store information that indicates if a device is an image forming device (printer) or an image processing device (controller) for expanding image processing relating to a print function of the image forming device in the device information. It is thereby possible to specify if a device is an image forming device (printer) or an image processing device (controller) and to perform the management thereof by referencing the device type 601 even in a case in which the serial numbers for the image processing device 102 and the image processing device 103 overlap.

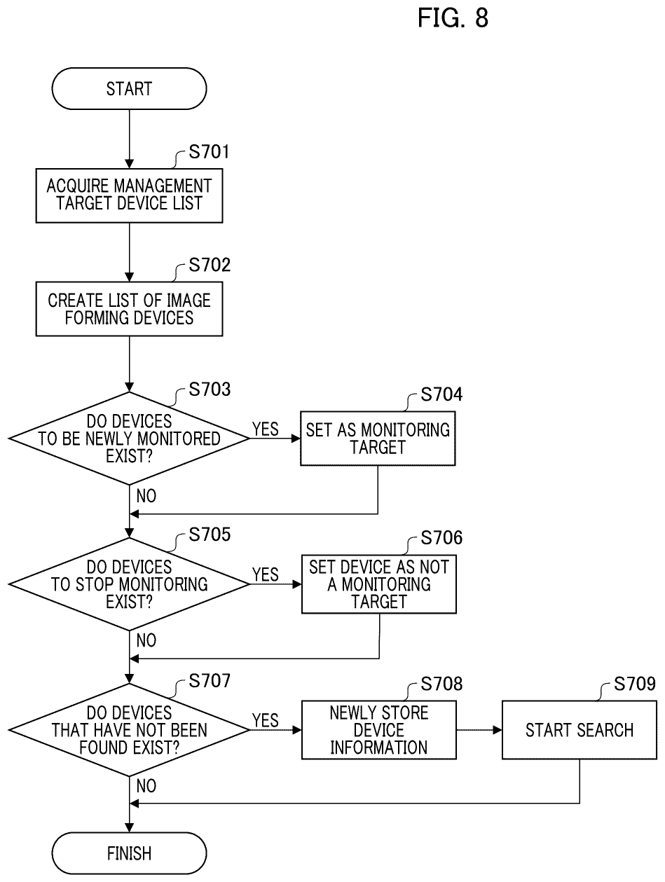

Next, processing will be explained in which the monitoring device 101 acquires the monitoring target device list from the management server 403. FIG. 8 is a flowchart showing monitoring target device list acquisition processing. In the present processing, the monitoring device 101 acquires the monitoring target device list from the management server 403, compares this with the list of image processing devices 103 that are managed by the monitoring device 101, and updates the monitoring target information 602 for the image processing devices 103. During the monitoring target device list acquisition processing, each processing that is executed by the monitoring device 101 is realized by the CPU 213 of the monitoring device 101 executing a program that has been stored on the storage device 212.

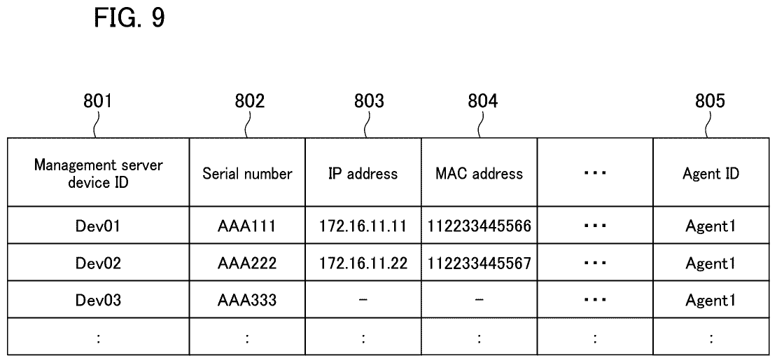

During S701, the server communications unit 404 acquires the monitoring target device list from the management unit 405 of the management server 403. In this context, the monitoring target device list will be explained. FIG. 9 is a diagram showing one example of a monitoring target device list. The monitoring target device list is device management information for the management server 403 that is managed by the management unit 405 of the management server 403. The management server 403 manages device information in which a device has been registered as a device that receives the provision of the device management service by the user on the monitoring target device list.

The monitoring target device list includes, for example, a management server device ID 801, a serial number 802, and an agent ID 805. In addition, the monitoring target device list may also include an IP address 803, and a MAC address 804. The management server device ID 801 is information for the management server 403 to uniquely identify a device that is a management target. The serial number 802 is fixed identification information that the manufacturer of a device adds in order to identify the device.

The IP address 803 is information that indicates the IP address of the device. The IP address 803 is information that is optionally input by the user when registering the device information on the screen control unit 408. The MAC address 804 is fixed identification information held by the network interface of the device. The MAC address 804 is information that is optionally input by the user when registering the device information on the screen control unit 408. The agent ID 805 is information that identifies an agent that is linked to a device (for example, the monitoring device 101). The timing at which device information is registered in the monitoring target device list is the timing at which a device is indicated and registered by a user as a target for the provision of the service. The method for indicating a device that is a target, may be, for example, performing a registration operation from a WebUI of the screen control unit 408, or may also be performing a registration operation using a WebAPI of the connection unit 409.

The monitoring target device list that is acquired from the management server 403 by the server communications unit 404 of the monitoring device 101 is a list of devices, from among the monitoring target device list that is managed by the management server 403, that are linked to the monitoring device 101. Upon receiving an acquisition request for the monitoring target device list during S701 from the monitoring device 101, the management server 403 specifies device information that is linked to the monitoring device 101 based on the agent ID 805 from the monitoring target device list, and transmits this to the monitoring device 101. The monitoring device 101 thereby acquires the monitoring target device list for which monitoring is performed in the monitoring device 101 from the management server 403.

The explanation will return to the flowchart. The monitoring device 101 performs an update of the device information such as whether or not a device is a management target by comparing the monitoring target device list that has been acquired from the management server 403 with the device information (FIG. 6) that is managed by the monitoring device 101. The monitoring target device list specifies the devices that are made monitoring targets using their serial numbers, and therefore, it is necessary to perform processing such that image processing devices 102 that have overlapping serial numbers with image processing devices 103 are not made monitoring targets in the monitoring device 101. In this context, the monitoring device 101 creates a list of just the image forming devices that have print functions, excluding the image processing devices (controllers) for expanding image processing relating to the print functions of the image forming devices. During S702, the management unit 106 creates a list of image forming devices that have print functions based on the device information (FIG. 6) that is managed by the monitoring device 101. The management device 106 generates a list by reading out devices other than devices for which the device type 601 is “controller”. According to the processing for S702, it is possible to exclude image processing devices 102 from the monitoring targets by not making devices for which the device type 601 is “controller” targets of the comparison.

During S703, the management unit 106 compares the monitoring target device list that was acquired during S701 with the list that was generated during S702, and confirms if there are any new devices to be monitored. Specifically, the management unit 106 first compares the serial numbers 802 of the monitoring target device list with the serial numbers 302 for the list that was generated during S702, and confirms if the serial numbers are the same. In addition, it confirms if any devices exist for which the monitoring target information 602 is “not a target” in the device information for the devices with serial numbers that are the same. In a case in which a device exists for which the serial numbers are the same, and the monitoring target information 602 in the list from S702 is “not a target”, it is determined that this is an existing device that is to be newly monitored, and the management unit 106 performs the processing for S704. In contrast, in a case in which no devices exist for which the serial numbers are the same, and the monitoring target information 602 in the list from S702 is “not a target”, it is determined that there are no existing devices that are to be newly monitored, and the processing for S705 is performed. During S704, the management unit 106 sets the monitoring target information 602 for the existing devices to be newly monitored that have been determined during S703 to “target”. In this context, by excluding the image processing devices 102, which are controllers, from the targets for the comparison in S702, there are no cases in which image processing devices 102 for which the monitoring target information 602 is “not a target” are made monitoring targets.

During S705, the management unit 106 compares the monitoring target device list that was acquired during S701 with the list that was generated during S702, and confirms if devices exist that have been excluded from the monitoring targets. Specifically, the management unit 106 confirms if, from among the devices that are not on the monitoring target device list, but that have serial numbers that are on the list that was generated during S702, a device exists for which the monitoring target information 602 is “target”. In a case in which a device does exist, from among the devices that are not on the monitoring device target list, but that have serial numbers that are on the list that was generated during S702, for which the monitoring target information 602 is “target”, it is determined that this is an existing device that will be excluded from the monitoring targets, and the processing for S706 is performed. In contrast, in a case in which no devices exist for which the monitoring target information 602 is “target” from among the devices that are not on the monitoring device target list but that have serial numbers that are on the list that was generated during S702, it is determined that there are no devices that are existing devices that will be excluded from the monitoring targets, and the processing for S707 is performed. During S706, the management unit 106 sets the monitoring target information 602 for the devices that have been determined to be existing devices that will be excluded from the monitoring targets in S705 as “not a target”. It is thereby possible to exclude the devices that have been excluded from the targets for the monitoring service in the monitoring target device list from the monitoring targets for the monitoring device 101.

During S707, the management unit 106 confirms if devices exist for which a new search is necessary. A device for which a new search is necessary is an image forming device that has a print function that should be a monitoring target in the monitoring device 101. Specifically, the management unit 106 compares the monitoring target device list with the list that was generated during S702, and confirms if devices exist on the monitoring target device list that are on the monitoring target device list but that have serial numbers that are not on the list that was generated during S702. In a case in which a device exists on the monitoring target device list that is on the monitoring target device list but that has a serial number that is not on the list that was generated during S702, it is determined that there is a device for which a new search is necessary, and the management unit 106 performs the processing for S708. In contrast, in a case in which no devices exist on the monitoring target device list that are on the monitoring target device list but that have serial numbers that are not on the list that was generated during S702, the present processing is completed. Note that even if an image processing device for which the device type 601 is “controller” exists that has a serial number that is the same as a serial number on the monitoring target device list, it is possible to determine that there is a device for which a new search is necessary by excluding the image processing devices 102 from the targets of the comparison during S702.

During S708, the management unit 106 newly stores the information for the device for which it was determined during S707 that a new search is necessary in the device information that is managed by the monitoring device 101. After this, the management unit 106 stores the monitoring target information 602 of the device information as “target”. By excluding image processing devices 102 from the targets for comparison during S702, it is possible to separately store and manage the device information for image processing devices 103 that have serial numbers that are the same as the serial numbers of the image processing devices 102 from the device information for image processing devices 102 during S709.

During S709, the search unit 107 executes the device search processing that is shown in FIG. 6 on the IP address 803 from the monitoring target device list that was stored during S708. In addition, in a case in which no IP address 803 is set in the monitoring target device list, if the user has set an IP address and host name in advance for the search on the screen control unit 108, the search may also be executed on this IP address. Note that instead of performing the search processing for S709 automatically, the user may also be notified of a message to the effect that it is necessary to perform a device search from the screen control unit 108. In addition, in a case in which a command for a device search has been received from the user, the monitoring device 101 executes the processing for S709. In addition, in a case in which there are only devices with serial numbers that are the same, but for which the device type 601 is “controller”, the user may also be notified of a message to the effect that a search for image processing devices 103 is necessary from the screen control unit 108.

Note that in a case in which the devices that are to be made monitoring targets are not designated in the management server 403, but are designated on the screen control unit 108 of the monitoring device 101, the monitoring target information 602 for an arbitrary device for which a search has already been performed may also be manually set as “target” on the screen control unit 108 without performing the processing for FIG. 8.

As was explained above, in the Present Embodiment, the monitoring device 101 stores information at the time of a device search as to if a device is an image processing device 102 (controller) or an image processing device 103 (printer), and manages the device information for both types of devices. By not excluding image processing devices 102 at the time of a device search of the monitoring device 101 and managing image processing devices 102 in the management unit 106, it is possible for a user to confirm the device information for the image processing devices from the screen control unit 108. In addition, by excluding the image processing devices 102 from the monitoring targets at the time of the acquisition of the monitoring target device list, it becomes possible to make only image processing devices 103 device targets even in cases in which the serial numbers for an image processing device 102 and an image processing device 103 overlap. It is thereby possible to collect only the data for image processing devices 103, which are monitoring targets, and transmit this data to the management server 403 while still managing both the image processing devices 102 and the image processing devices 103 in the monitoring device 101. In contrast, it is possible to make it such that data is not collected from the image processing devices 102, which are not monitoring targets, and such that the transmission of this data is also not performed to the management server 403. In addition, it is also possible to notify the user when there is a state in which an image processing device 102 can be found, but an image processing device 103 having the same serial number as this image processing device 102 cannot be found.

### Third Embodiment

In the First Embodiment and the Second Embodiment, at the time of a device search by the monitoring device 101, it was identified if a device is the image processing device 102 (controller) or if a device is the image processing device 103 (printer). However, if processing is performed at the time of a search to identify whether or not a device is the image processing device 102, the load for the search processing will increase, and it is possible that this will take more time when a wide range of IP addresses are being searched. In this context, in the Present Embodiment, after the device search, processing to identify whether or not a device is the image processing device 102 (controller) is performed after having stored the device information, and the load for the device search is lightened. In this case, during the period from after the search is finished until the identification processing is performed, it is necessary to execute processing that takes into account the existence of devices for which it is not known if they are image processing devices 102 or if they are image processing devices 103.

The hardware configuration and the software configuration of the Present Embodiment are the same as the hardware configuration and the software configuration in the Second Embodiment, and therefore, explanations thereof will be omitted. In the Present Embodiment, processing is not performed at the time of a device search to identify if a device is the image processing device 102 (controller) or the image processing device 103 (printer). Therefore, the device search processing by the monitoring device 101 in the Present Embodiment becomes processing that is the same as the device search processing in the First Embodiment that is shown in FIG. 3, but in which after the information has been acquired during S203, all of the information that has been found is stored during S205, and the processing for S204 is not performed.

During the monitoring target device setting processing for S709, if the device search processing of the Present Embodiment is performed, differentiation of the image processing devices 102 and the image processing devices 103 is not performed at the time of the search, and therefore devices that have previously been found will become devices for which the monitoring target information 602 is “target”. In addition, devices that have been found after this will be newly stored as devices for which the monitoring target information 602 is “not a target”. More specifically, first, during S708, the device information is stored with the monitoring target information as “target”, and devices that have not been searched for yet are searched for during S709. If the MAC address 804 for the monitoring device list has been input, the MAC address is made the key, and if a device for which the MAC address is the same is found, the device information is over written. In contrast, in a case in which the MAC address for the monitoring device list is not set, if a device that has a serial number that is the same as a serial number 802 on the monitoring device list is found, the device information is over written. At this time, the differentiation of the image processing devices 102 (controllers) and the image processing devices 103 (printers) is not performed during the search, and therefore, devices that have been previously found are stored in the device information that is managed by the monitoring device 101 as devices for which the monitoring target information 602 is “target”.

In addition, when device information for devices that were found during the device search processing in S205 is stored, it may also be made such that the device information that was acquired during S203 is compared with the already existing device information, and the device information is stored according to the results of this comparison. For example, in a case in which a device already exists that has the same serial number as a device that has been found and for which the device type is “controller”, and for which the MAC address is different than the MAC address for the device that was found, it is determined that the device that has been found is an image forming device, and the information for this device is over written. In this case, the ability 603 may also be returned to “unclear”. In addition, in a case in which a device already exists that has the same serial number as a device that has been found and for which the device type is “printer”, but for which the MAC address is different than the device that has been found, it may also be made such that it is determined that the device that has been found is an image processing device, and the processing is completed without storing the information that has been found. In this manner, by not performing confirmation processing for whether or not a device is the image processing device 102 in order to discard the information for the image processing devices 102 during S204, but performing storage according to the above-described comparison when storing information in S205, it is possible to lighten the processing load for after this. Specifically, the processing for identifying the image processing devices 102 during the processing for the ability check, which will be described below, and the processing for transferring a management state become unnecessary, and the processing load for the ability check can be lightened.

The monitoring target device setting processing by the monitoring device 101 in the Present Embodiment is the same as the processing in the Second Embodiment (FIG. 7) and therefore, an explanation thereof will be omitted. In the Present Embodiment, during the search processing, the device type is not identified, and the device type 601 of the device information is not stored. Therefore, during the creation of the list in S702, if a list is generated by reading out the devices other than the devices for which the device type 601 is “controller”, devices for which the device type identification has not been completed will also be included in the list. In addition, the devices that have been included in the list will be set as monitoring targets during S704 if they have serial numbers that are the same in S703.

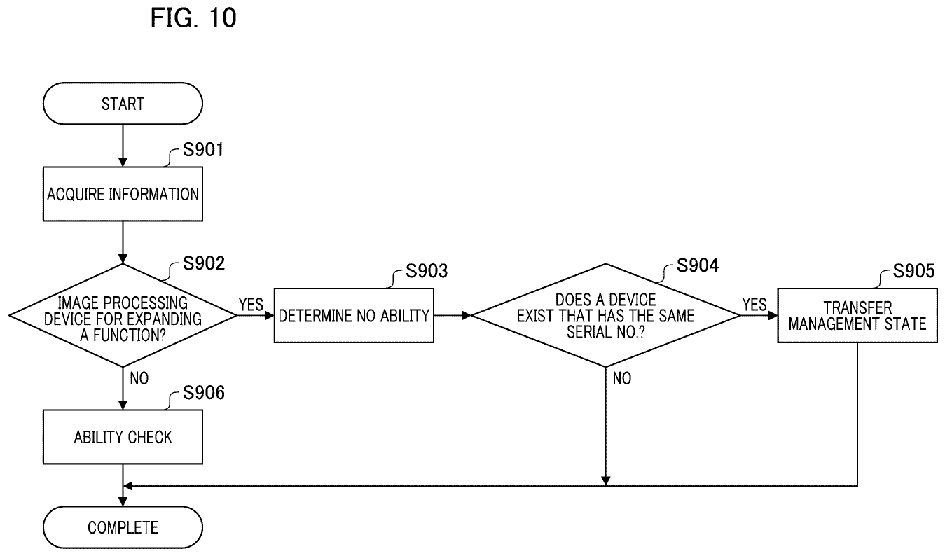

In the Present Embodiment, the exclusion of image forming devices and the differentiation of device types are not performed at the time of a device search, and therefore, device type identification and processing to transfer the management state of the image processing devices 102 to the image processing devices 103 are performed during the ability check processing. FIG. 10 is a flowchart showing ability check processing. During the ability check processing, when the monitoring device 101 is checking if a device has the ability to be able to acquire information that is necessary for monitoring from the device, the monitoring device 101 identifies whether or not the device is the image processing device 102 (controller), and determines that it does not have this ability in a case in which the device is the image processing device 102. Furthermore, in a case in which there is an existing device that has the same serial number, the management information is transferred to the existing device. It is thereby possible to exclude image processing devices 102 from the monitoring targets.

The ability check processing may be executed after the monitoring device has completed the search, it may also be executed periodically, or it may also be executed at an arbitrary timing according to a command from the user by an operation of the screen control unit 108. Each processing that the monitoring device 101 executes during the ability check processing is realized by the CPU 213 of the monitoring device 101 executing a program that has been stored on the storage device 212.

During S901, the management unit 106 acquires information from the device. In this context, the information that is acquired includes device information (FIG. 4) that is managed by the monitoring device 101 in the same manner as the information that is acquired during S203. In addition, this may also include information that is acquired by the unique communications protocol of the maker that is defined by the maker of the image processing device, counter information that is acquired from the device at the time of monitoring, log information, or information as to whether or not status/alert information or the like can be acquired.

During S902, the confirmation unit 119 confirms whether or not the device is an image processing device (controller) for expanding image processing relating to a print function of an image forming device based on the information that has been acquired during S901. For example, in a case in which a specific character string exists in the information such as the product name 305, the manufacturer name 306, or the like that were acquired during S901, the management unit 106 determines that a device is the image processing device 102. In addition, in a case in which the manufacturer name is a specific character string, the management unit 106 may also determine that a device is the image processing device 102 in a case in which information cannot be acquired by the unique communications protocol of the maker. In addition, the management unit 106 may also determine that a device is the image processing device 102 in a case in which the private MIB of the maker can be acquired, but information cannot be acquired by the unique communications protocol of the maker. In a case in which it has been determined that a device is an image processing device (controller) for expanding image processing relating to a print function of an image forming device, the monitoring device 101 performs the processing for S903. In contrast, in a case in which it has been determined that a device is not an image processing device (controller) for expanding image processing relating to a print function of an image forming device, the monitoring device 101 performs the processing for S906.

During S903, the management unit 106 determines that a device is an image processing device (controller), and does not have monitoring abilities, and stores the device information with the ability 603 set as “no”. During S904, the management unit 106 identifies whether or not an existing device that has the same serial number as the device that has been determined to be an image processing device (controller) is already being managed. In a case in which there is an existing device with the same serial number that is already being managed by the monitoring device, the processing for S905 is performed.

In contrast, in a case in which there are no existing devices being managed that have the same serial number, the present processing is completed. In this context, in a case in which an existing device having the same serial number as an image processing device (controller) is not being managed, the user may also be notified of a message to the effect that it is necessary to search for the image processing device 103 having this serial number on the screen control unit 408. The user may be notified on the screen control unit 108 by transmitting information to the collection unit 407 of the management server 403 from the server communications unit 404, or the user may also be notified by email via an external mail server.

During S905, the management unit 106 transfers the management state of the image processing device (controller) to the existing device that has the same serial number as the image processing device (controller). Specifically, in a case in which the management state (monitoring target information 602) of the image processing device (controller) is that this is a management target, the management state of the image processing device (controller) is made not a management target, and the management state of the existing device that has the same serial number is made a management target.

During S906, the management unit 106 determines whether or not a device has a self-monitoring ability based on the information that was acquired during S901. The determination as to whether or not a device has monitoring abilities is performed based on, for example, information as to whether or not counter information, log information, status/alert information, or the like can be acquired from the device. In addition, the management unit 106 stores the information about the presence or absence of self-monitoring abilities in the ability 603.

A case is imagined in which only devices that are the image processing devices 102 (controllers) have been found, and no image processing devices 103 (printers) having the same serial numbers have been found. In such a state, in a case in which ability check processing is not executed on the devices, a device cannot be identified as being the image processing device 102 or the image processing device 103, and during the acquisition processing for the monitoring target device list, the monitoring target information 602 for the device temporarily becomes “target”. In such a state, during S904, there are no existing devices that are already being managed that have the same serial number as the image processing device 102, and therefore, the processing ends as is, with the monitoring target information 602 remaining “target”. After this, when the ability check processing is executed again after having found the image processing device 103 that has the same serial number, during S905, the monitoring target information for the image processing device 103 becomes “target”.

As has been described above, according to the Present Embodiment, device type identification processing is not performed at the time of a device search by the monitoring device 101, and processing for the identification of the device type and the transfer of the management state of the image processing device 102 to the image processing device 103 is performed during the ability check processing, which is executed after the search. It thereby becomes possible to monitor only the image processing devices 103 while lightening the load at the time of the device search.

Embodiment(s) of the present invention can also be realized by a computer of a system or device that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or device by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc(BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-176257, filed Oct. 11, 2023, which is hereby incorporated by reference herein in its entirety.

What is claimed is:

1. A monitoring device monitoring image processing devices via a network, the monitoring device comprising:
a memory storing instructions; and
a processor executing the instructions causing the monitoring device to:
search for image processing devices on the network;
confirm whether or not an image processing device is an image processing device for expanding image processing relating to a print function, in a case in which a plurality of image processing devices having serial numbers that are the same but different IP addresses have been found during the search; and
manage, from among the plurality of image processing devices, an image processing device that is not an image processing device for expanding image processing relating to a print function as an image processing device that is a management target that is provided with a print function.

2. The monitoring device according to claim 1, wherein from among the plurality of image processing devices, device information for an image processing device that is an image processing device for expanding image processing relating to a print function is not stored.

3. The monitoring device according to claim 1, wherein from among the plurality of image processing devices, management is performed by differentiating an image processing device that is an image processing device for expanding image processing relating to a print function, and an image processing device that is not an image processing device for expanding image processing relating to a print function.

4. The monitoring device according to claim 3, wherein an image processing device that is an image processing device for expanding image processing relating to a print function is managed as an image processing device that is not a management target.

5. The monitoring device according to claim 3, wherein the processor acquires a device list showing image processing devices that are targets of monitoring by the monitoring device from a device management service, compares the device list with a list of image processing devices that are not image processing devices for expanding image processing relating to a print function, and manages an image processing device that have same serial number that is the same as an image processing device on the device list as an image processing device that is a management target.

6. The monitoring device according to claim 1, wherein the processor does not perform confirmation as to whether or not an image processing device is an image processing device for expanding image processing relating to a print function on the plurality of image processing devices that have been searched, and manages the plurality of image processing devices that have been searched, and
the processor confirms whether or not a device is an image processing device for expanding image processing relating to a print function when confirming a self-monitoring ability corresponding to a device management service provided by an image processing device.

7. The monitoring device according to claim 1, wherein the processor confirms whether or not an image processing device is an image processing device for expanding image processing relating a print function based on at least one of a product name or a manufacturer name of an image processing device, or whether or not information can be acquired using a specific protocol.

8. A control method for a monitoring device monitoring information processing devices via a network, the control method comprising:
searching for image processing devices on the network;
confirming whether or not an image processing device is an image processing device for expanding image processing relating to a print function, in a case in which a plurality of image processing devices having serial numbers that are the same but different IP addresses have been found during the searching; and
managing, from among the plurality of image processing devices, an image processing device that is not an image processing device for expanding image processing relating to a print function as an image processing device that is a management target that is provided with a print function.

9. A non-transitory storage medium storing a control program of a monitoring device monitoring image processing devices via a network, the control program causing a computer to perform each step of a control method of the monitoring device, the method comprising:
searching for image processing devices on the network;
confirming whether or not an image processing device is an image processing device for expanding image processing relating to a print function, in a case in which a plurality of image processing devices having serial numbers that are the same but different IP addresses have been found during the searching; and
managing, from among the plurality of image processing devices, an image processing device that is not an image processing device for expanding image processing relating to a print function as an image processing device that is a management target that is provided with a print function.
